(19) United States
(12) Patent Application Publication
(10) Pub. No.: US 2024/0049676 A1
(43) Pub. Date: Feb. 15, 2024

(54) USE THE CARDBOARD BOX

(71) Applicant: Karen Elise Wormack, Long Pond, PA (US)

(72) Inventor: Karen Elise Wormack, Long Pond, PA (US)

(21) Appl. No.: 17/818,684

(22) Filed: Aug. 9, 2022

(51) Int. Cl. A01K 1/015; B65D 81/36

(52) U.S. Cl. CPC A01K 1/0155; B65D 81/36

(57) ABSTRACT

This invention uses clean corrugated cardboard for “Use the Cardboard Box” Animal/Cat/Kitty Litter. Cat litter is used by felines to bury their urine and feces. “Use the Cardboard Box” serves as a biodegradable, highly absorbent, easy to use and easy to discard “Kitty Litter” for Animal/Cat/Kitty biological waste burial, absorbency and temporary containment inside a litter box. “Use the Cardboard Box” consists of any color, size, shape and weight of corrugated cardboard, which is processed manually or by industrial machine(s), thus being cut or molded from an obtained and enormous supply of completely flat corrugated cardboard and formed into crinkled, spiral, pellet, shredded, cut, sliced, chopped, diced, rippled, smooth, bulky, chunky or cubes of multiple or single shaped textured corrugated cardboard box pieces to produce “Use the Cardboard Box” Animal/Cat/Kitty Litter. “Use the Cardboard Box” helps the environment recover from pollution, is lightweight and convenient to use.

### BACKGROUND OF THE INVENTION

Protection and care of domestic pets is important to having them live well and thrive. According to statistics one in three households—37 million in all—has at least one pet cat, with an average of 2.2 cats living in each cat-owning household. This means there are approximately 82 million pet cats living in people's homes throughout the United States. All of these “indoor” cats need a box or pan for collecting excreted waste, made of various materials including cardboard, plastic, metal or other materials, as well as clean litter poured or shaken inside the box or pan for biological waste burial, absorbency and temporary containment inside the litter box. Traditionally, clay litter has been used. However, for the past six years, the inventor of “Use the Cardboard Box” has been manually shredding all types of corrugated cardboard and has used this undiscovered technique to take the place of heavy clay litter. This method of Animal/Cat/Kitty Litter is so effective it is the only litter used in the Inventor's home.

Moreover, indoor cats and kittens become trained to know where to find their litter boxes, and cleanliness of the litter box or litter pan is especially important. Kittens can easily adapt to “Use the Cardboard Box” Animal/Cat/Kitty Litter. Adult cats having become accustomed to using traditional clay litter can also adapt to accepting “Use the Cardboard Box” Animal/Cat/Kitty Litter if it is gradually introduced by being mixed into their existing clay litter and box. This information and the instructions for gradual introduction are printed on the proposed packaging for “Use the Cardboard Box”. Cats and Kittens also enjoy scratching surfaces throughout the day, including scratching their litter after use. “Use the Cardboard Box” Animal/Cat/Kitty Litter is also scratchable, yet nonabrasive as traditional cat litter is gritty and abrasive.

Furthermore, “Use the Cardboard Box” Animal/Cat/Kitty Litter helps solve many problems. Firstly, indoor, confined space, or hospitalized cats always need fresh litter. Otherwise, they will biologically relieve themselves in unexpected places. Traditional clay litters are not eco friendly and are heavy, messy, dusty, harbor germs, bacteria and sometimes parasites. Consequently, a wider variety of cat litter products have come to the retail marketplace including 1. Clumping and Traditional Non-Clumping Clay Litter 2. Silica Gel Litter 3. Pine Litter 4. Wheat Litter 5. Grass Litter 6. Corn Litter 7. Walnut Shell Litter and 8. Newspaper Litter. However, there is no biodegradable manually cut or professionally cut and or molded into various shapes of corrugated cardboard Animal/Cat/Kitty Litter product available for retail purchase. The Inventor also conducted a patent search for corrugated cardboard Animal/Cat/Kitten Litter and no patent(s) was found for this specific search. Hence, the Inventors excitement grew.

Additionally, after market corrugated cardboard boxes are made flat by hand or crushed by machine and flattened for export, when their contents of packaged products shipped inside these boxes are stocked on store shelves. Retailers need to discard this left-over material of corrugated boxes. The Nation of China was once one of America's largest importers of this constantly used recycled “aftermarket” product. However, China informed the World Trade Organization their country was banning “Waste” imports from the United States in July of 2017. Since then, the onus of properly discarding corrugated cardboard excess has become an unprofitable task for retailers. “Use the Cardboard Box” functional use for Animal/Cat/Kitty Litter helps solve a constant problem for disposing of clean corrugated cardboard with streamlined ease, by repurposing the material within the United States as an Animal/Cat/Kitty Litter.

Veterinarians and Animal Hospitals will also receive help from “Use the Cardboard Box Animal/Cat/Kitty Litter for use with their clawed and declawed felines (cats), and when urine samples are needed, which can quickly be collected with a tilt of the litter pan, before urine absorption occurs from “Use the Cardboard Box” Animal/Cat/Kitty Litter.

### SUMMARY OF THE INVENTION

“Use the Cardboard Box” is an Animal/Cat/Kitty Litter which is a biodegradable, eco-friendly, method of using various sizes of clean corrugated cardboard, consisting of any color, size, shape and weight, which is processed manually or by industrial machine(s), thus being cut or molded from an enormous supply of completely flat corrugated cardboard boxes and formed into crinkled, spiral, pellet, shredded, cut, sliced, chopped, diced, rippled, smooth, bulky, chunky, or cubes of multiple or single shaped textured corrugated cardboard box pieces to produce “Use the Cardboard Box” Animal/Cat/Kitty Litter for excreted waste burial, absorbency and temporary containment inside a litter box. Hence solving different problems including but not limited to heavy, messy, dusty, traditional clay litter, which can easily harbor germs, bacteria and parasites, as well as making excellent use of an unwanted yet recyclable product, no longer desired by overseas importers from United States Retailers.

### BRIEF DESCRIPTION OF THE DRAWING

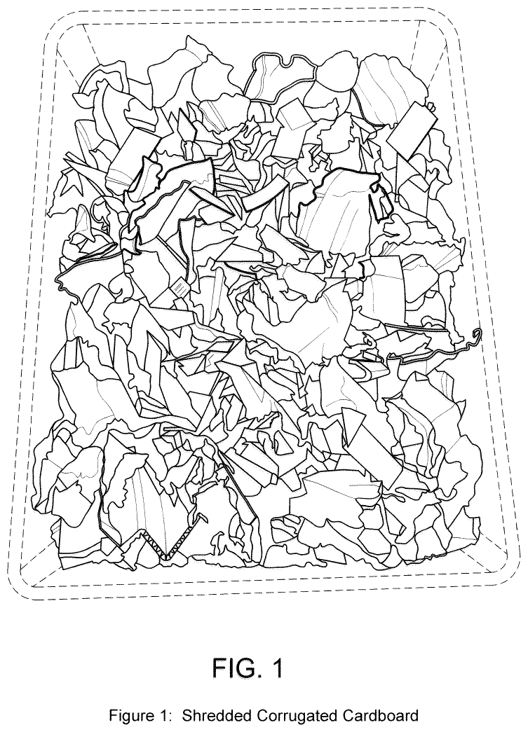

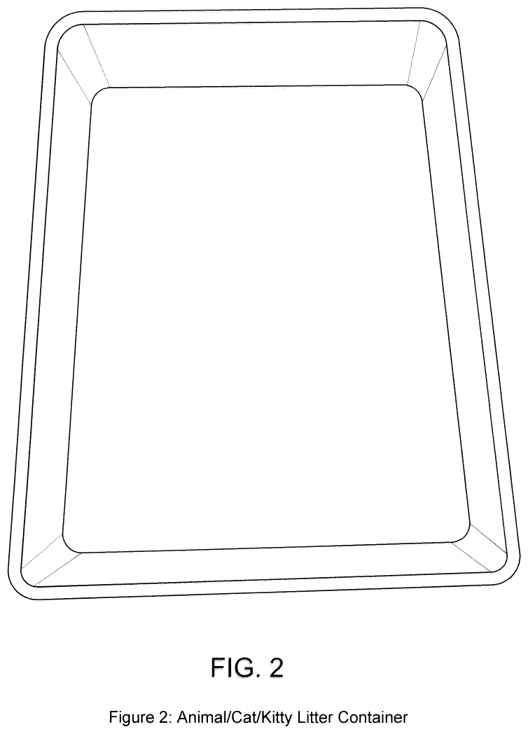

The drawing of “Use the Cardboard Box” Animal/Cat/Kitty Litter illustrates corrugated cardboard shredded by a woodchipper machine. An industrial cardboard shredding machine will produce the same effect with a more shredded less chunky shape. “Use the Cardboard Box” Animal/Cat/Litter is exhibited in its shredded form (FIG. 1). An animal, cat or kitty litter container is exhibited in (FIG. 2).

### DETAILED DESCRIPTION OF THE INVENTION

“Use the Cardboard Box” biodegradable, hand cut or professionally cut and or molded Animal/Cat/Kitty Litter is made from flattened accumulated corrugated cardboard, used by manufacturers, distributors, businesses, and corporations to ship various quantities of products to myriads of retail and grocery stores for stocking shelves and selling merchandise. Corrugated cardboard is a natural material made from a variety of tree fibers, water and starch. Most commercial starch is made from corn, although wheat, tapioca, and potato starch are also used.

Once corrugated cardboard boxes have been opened and the shelves stocked, these empty cardboard containers are broken down to a flat position by hand or machine, then bound in stacks and heaps for pick up by a recycling company or thrown away in very large dumpsters, marked: “BOXES ONLY” and taken to a landfill or recycling center by a garbage disposal company. Hence, “Use the Cardboard Box” Animal Cat/Kitten Litter is made from existing clean corrugated cardboard, retrieved with permission from various retail and grocery stores then remanufactured into effective and easily disposable Animal/Cat/Kitty Litter.

“Use the Cardboard Box” serves as a biodegradable, highly absorbent, easy to use and easy to discard “Kitty Litter” for Animal/Cat/Kitty biological waste burial, absorbency and temporary containment inside a litter box. “Use the Cardboard Box” consists of any color, size, shape and weight of corrugated cardboard, which is processed manually or by industrial machine(s), thus being cut or molded from an enormous supply of completely flattened corrugated cardboard and formed into crinkled, spiral, pellet, shredded, cut, sliced, chopped, diced, rippled, smooth, bulky, chunky or cubes of multiple or single shaped textured corrugated cardboard box pieces to produce “Use the Cardboard Box” Animal/Cat/Kitty Litter.

Upon retrieval of corrugated cardboard boxes, the aftermarket product is taken to a commercial location where industrial strength cardboard machines, or industrial strength wood-chippers, are waiting (this job can also be performed by hand using manual labor) to professionally cut, shred, or mold the discarded boxes into a green, environmentally, safe, effective and friendly, all new biodegradable, professionally cut, shredded or molded, recycled corrugated cardboard animal litter, especially for cats and kittens. The new product material “Use the Cardboard Box” is captured in large containers, making it ready for consumer sales after the individual product bags (containing printed marketing and usage information) are filled to their intended label capacity and weight. A commercial, industrial strength digital scale is used for precise weight management. The product is distributed into individual “Use the Cardboard Box” Animal/Cat/Kitten Litter bags, sealed and ready for retail sales. Each bagged product of “Use the Cardboard Box” has an identifying bar code and selling price.

The Inventor has already begun testing and implementing this amazing idea and product for private use with our own cat, kitten family and it works effectively. In fact, we have not purchased regular clay litter for our feline family in several years.

Benefits of “Use the Cardboard Box” Animal/Cat/Kitten Litter
Moisture Absorbent Biodegradable Hand Cut or Professionally Shredded, Cut or Molded into Shapes Including but not Limited to Pellet Shapes
Fantastic Replacement or Additive for Conventional Clay Litter
Lasts Longer than Conventional Clay Litter
Reduces Odors
Has Little to No Dust
Excellent for Animals/Multiple Cats/Kittens
Saves Money
Easy to Carry
Less Mess
Biodegradable
Recyclable
Helps Reduce Pollution Keeping the Earth Green

1. “Use the Cardboard Box” is comprised of manually cut or industrial cut or molded, clean corrugated cardboard, this type of cardboard being often made with three different layers, the two outer layers having a smooth surface while the central inner layer is corrugated, also referred to as a fluted center, whereas the corrugated cardboard having a variety of colors, albeit brown is most popular, using any size, shape and weight of corrugated cardboard to be cut or molded from an initial completely flattened or crushed supply of corrugated cardboard, then processed manually or by industrial machine into crinkled, spiral, pellet, shredded, cut, sliced, chopped, diced, rippled, smooth, bulky, chunky, or cubes of multiple or single shaped corrugated cardboard box pieces, to produce “Use the Cardboard Box” Animal, Cat, Kitty Litter, whereas this output biodegradable material is collected inside a holding container, then evenly distributed into individual bags according to appropriated weight, whereas the final destination of “Use the Cardboard Box” Animal, Cat and Kitty Litter is poured, sprinkled or dumped into an existing litter box for biological waste burial, absorbency and temporary containment of such, until it's time to properly discard the soiled litter and refill said litter box with unused portions of “Use the Cardboard Box” Animal, Cat and Kitty Litter.
